(19) United States
(12) Patent Application Publication
(10) Pub. No.: US 2006/0267352 A1
(43) Pub. Date: Nov. 30, 2006

(54) Gate latch

(76) Inventor: Walter F. Childress, La Mirada, CA (US)

Correspondence Address: AVERILL & VARN, 8244 PAINTER AVE., WHITTIER, CA, 90602, US

(21) Appl. No.: 11/138,937

(22) Filed: May 25, 2005

(51) Int. Cl. E05C 19/10

(52) U.S. Cl. 292/246

(57) ABSTRACT

A latch comprises a chain and a receiver. Brackets are attached to the receiver to attach the receiver to a first vertical member. The chain is attached to a chain bracket configured to attach to a second vertical member. A gate is secured in a closed position by engaging the chain with a slot in the receiver. The slot is substantially vertical for vertically accepting the chain, and the receiver includes a ramp for guiding the chain downward and away from the first vertical member and into the slot. Notches are provided in the slot to grasp the chain against motion of the gate or the chain.

### BACKGROUND OF THE INVENTION

The present invention relates to gate latches and in particular to easily manipulated latches for frequently opened and closed gates.

There are a variety of latches used on various gates. A common gate in an equestrian area is a pipe gate which is commonly used with a pipe stall or other facility. The stalls are generally rented and the renters often provide their own latch. There is thus a need for an easily installable and removable latch suitable for horse stalls.

Further, due to the nature of horse care, the stalls must be frequently cleaned. Such cleaning often involves entering and leaving the stall multiple times, often when the horse is in the stall, requiring a latch which is conveniently manipulated. Other times, the horse may be removed from the stall, requiring a latch which is easily manipulated with one hand while the horse is controlled by another hand. Additionally, because of the size and weight of horses, the latch must remain locked when substantial weight is placed against the gate.

### BRIEF SUMMARY OF THE INVENTION

The present invention addresses the above and other needs by providing a latch comprising a chain and a receiver. Brackets are attached to the receiver to attach the receiver to a first vertical member. The chain is attached to a chain bracket configured to attach to a second vertical member. A gate is secured in a closed position by engaging the chain with a slot in the receiver. The slot is substantially vertical for vertically accepting the chain, and the receiver includes a ramp for guiding the chain downward and away from the first vertical member and into the slot. Notches are provided in the slot to grasp the chain against motion of the gate or the chain.

In accordance with one aspect of the invention, there is provided a gate latch comprising a chain and a receiver. The chain is configured to attach to a second vertical member defining a second vertical edge of one of a gate and a gate opening. The receiver is configured to attach to a first vertical member defining a first vertical edge of another of the gate and the gate opening. The receiver includes a substantially vertical slot configured to vertically receive the chain and to resist a horizontal motion of the chain through the slot. A guide resides proximal to the slot and is configured to reside proximal to the first vertical member and to slope away from the first vertical member and downwards towards the slot.

In accordance with another aspect of the invention, there is provided a gate latch comprising a chain and a receiver. A vertical bracket is configured to attach to a first vertical member defining a first vertical edge of one of a gate and a gate opening, and the receiver is attached to the vertical bracket. The chain is configured to attach to a second vertical member defining a second vertical edge of one of the gate and the gate opening. The receiver includes a substantially vertical slot configured to vertically receive the chain and to resist a horizontal motion of the chain through the slot. A guide resides proximal to the slot, and is configured to reside proximal to the first vertical member and to slope away from the first vertical member and downwards towards the slot.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a prior art pipe stall.

FIG. 2 is a pipe stall with a gate latch according to the present invention.

FIG. 3 is a detailed vew of the gate latch and gate.

FIG. 4A is the gate latch in an unlatched condition.

FIG. 4B is the gate latch in a latched condition.

FIG. 5A shows a chain residing against a first vertical member.

FIG. 5B shows the chain lowered to a guide.

FIG. 5C shows the chain in a slot of a receiver.

FIG. 6A is a side view of the chain attached to a chain bracket.

FIG. 6B is a top view of the chain attached to the chain bracket.

FIG. 7A is a side view of a receiver attached to a vertical bracket and a horizontal bracket.

FIG. 7B is a top view of the receiver attached to the vertical bracket and the horizontal bracket.

FIG. 8 shown a receiver with notches in the slot.

FIG. 8A is a cross-sectional view taken along line 8A-8A of FIG. 8 of the receiver showing the notches.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

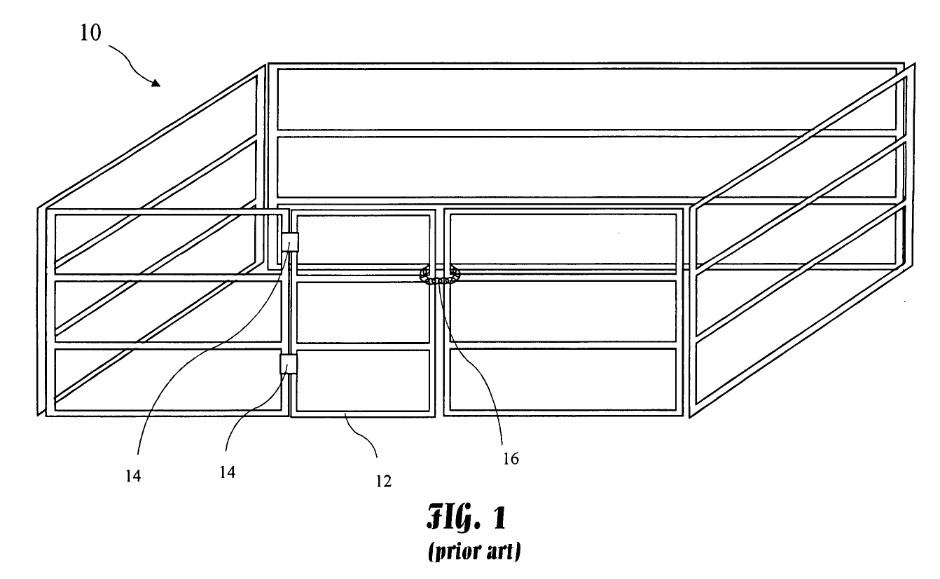

A prior art pipe stall 10 commonly seen in horse facilities is shown in FIG. 1. The stall 10 includes a gate 12 with hinges 14 and a chain 16 used to secure the gate 12. Using the chain 16 to secure the gate 12 generally requires two hands. Often, a rider must lead a horse while opening and then closing the gate 12. The need to use two hands to secure the gate 12 creates additional work for a rider, and may result in the horse getting loose if the rider is not careful. Other times, a stable hand may need to open and close the gate several times in the course of cleaning the stall. The effort required to secure the prior art stall while carrying material may result in failures to adequately secure the stall, and again, the horse may get loose.

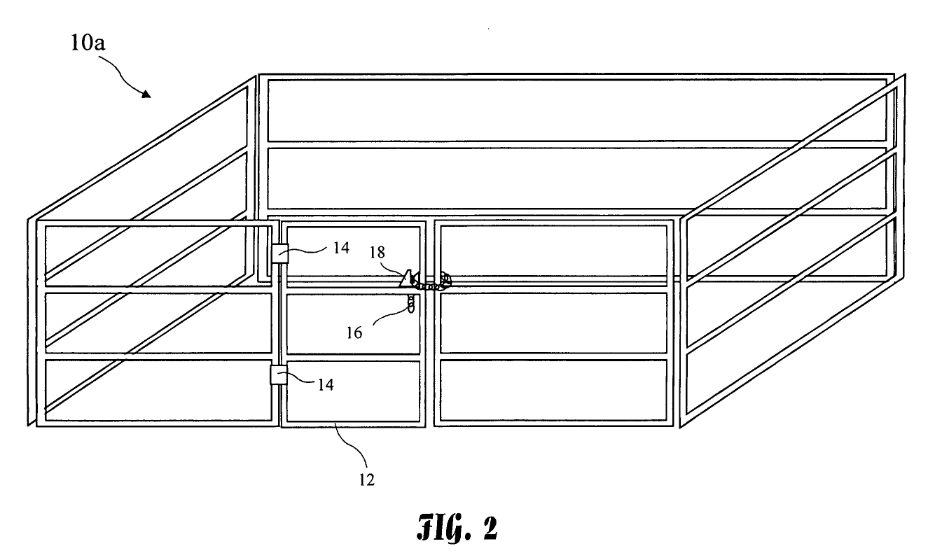

A pipe stall 10a with a gate latch according to the present invention is shown in FIG. 2. The gate latch includes a receiver 18 which accepts the chain 16 to secure the gate 12. As shown in more detail in FIG. 3, the receiver 18 includes a slot 20 for receiving the chain 16, and a guide 22 for guiding the chain 16 into the slot 20. The slot 30 is substantially vertical, i.e., the slot is close enough to vertical to allow the chain 16 to freely fall to the bottom of the slot 20 once the chain 16 enters the slot 20.

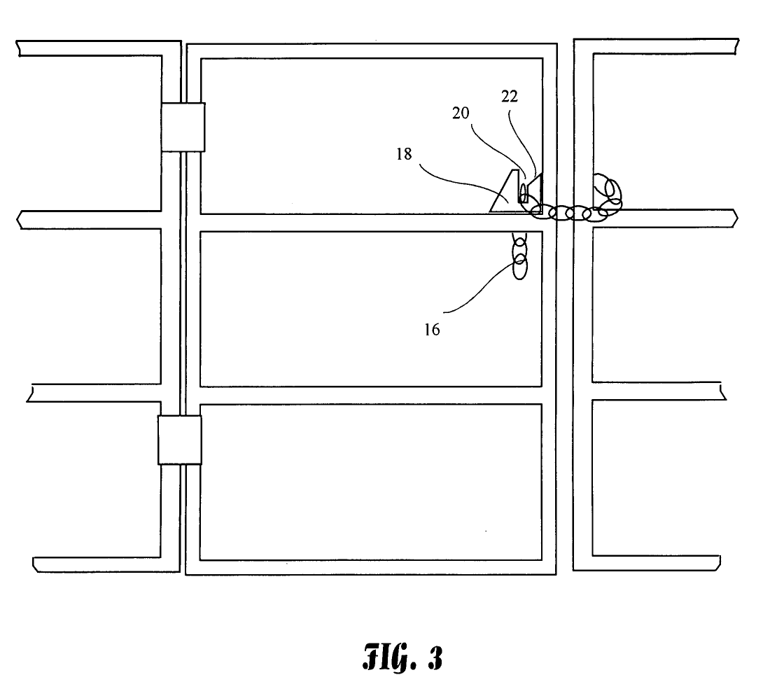

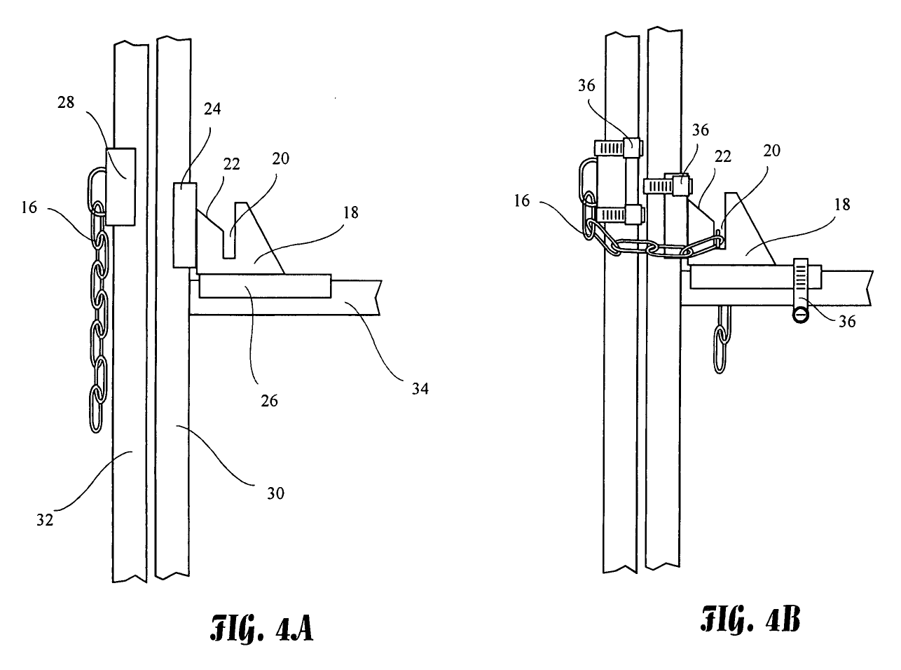

The gate latch is shown in an unlatched condition in FIG. 4A, and in a latched condition in FIG. 4B. The receiver 18 is attached to a first vertical member 30 and the chain 16 is attached to a second vertical member 32. The vertical member 30 preferably comprises a first vertical edge of one of the gate 12 and a gate opening in the coral 10a, and the vertical member 32 preferably comprises a second vertical edge of another of the gate 12 and the gate opening in the coral 10a. Thus, the receiver 18 may be attached to either the gate 12 or to a portion of the bar coral 10a adjacent to the gate 12.

The receiver 18 is attached to a vertical bracket 24 and a horizontal bracket 26. The bracket 24 attaches to the vertical member 30 and the bracket 26 attaches to a horizontal member 34. The chain 16 is attached a chain bracket 28 which is attached to the second vertical member 32. The brackets 24, 26, and 28 may be attached using common hose clamps 36, or may be welded to the members 30. 32, and/or 34. Further, the chain 16 may be welded to the member 32, or may be wound around the member 32 and secured by a spring latch, a bolt, or the any other fastener. The receiver 18 and/or chain 16 are often provided by a renter of the stall 10a, and are preferably removable.

The gate latch of the present invention provides the ability to secure the gate 12 by a simple one handed action. Such action is shown in steps in FIGS. 5A, 5B, and 5C. First, the chain 16 is shown sliding down the member 30. When the chain 16 reaches the receiver 18, the guide 22 provides a substantially smooth (e.g., sufficiently smooth for the chain 16 to slide downward on the guide 22) surface to guide the chain 16 downward and toward the slot 20. The chain 16 then slides off the guide 22 and into the slot 20.

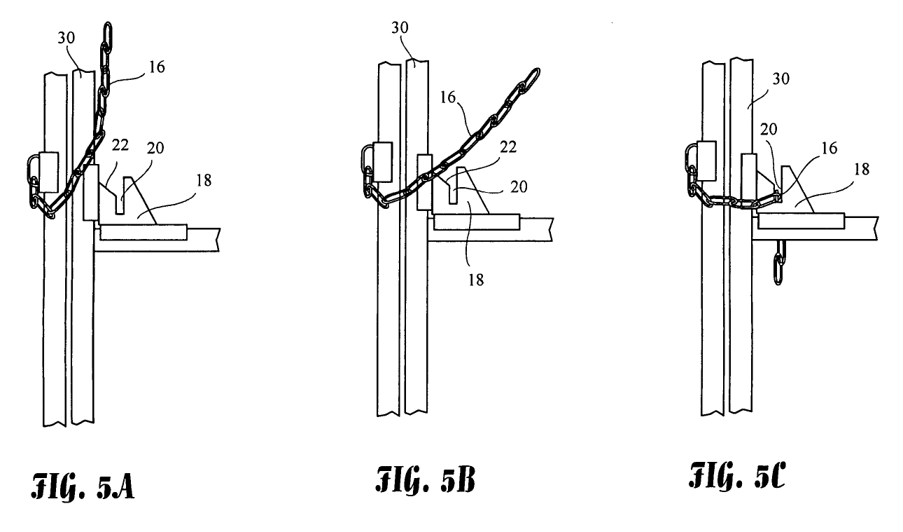

A side view of the chain 16 attached to the chain bracket 28 is shown in FIG. 6A, and a top view of the chain 16 attached to the chain bracket 28 is shown in FIG. 6B. The bracket 28 preferably substantially conforms to a profile of the vertical member 32, i.e., the bracket 28 is preferably shaped to reside closely against the vertical member 32 when the hose clamp 36 (see FIG. 4B) is tightened around the bracket 28 and the vertical member 32, and is more preferably approximately semi circular or slightly more than a semi circle to allow the bracket 28 to snap onto the vertical member 32 to make assembly easier (e.g., the bracket will temporarily grasp the vertical member until the bracket is secured.)

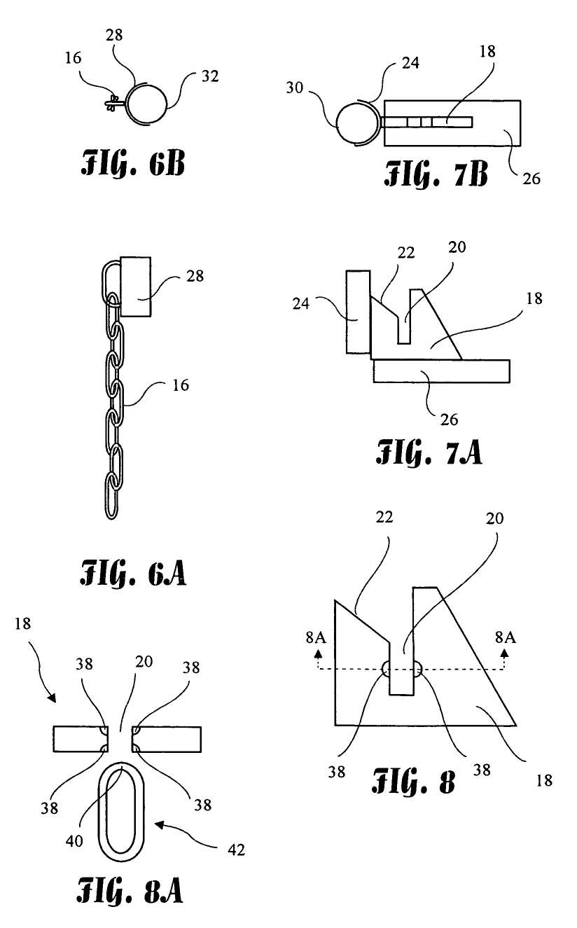

A side view of the receiver 18 attached to the vertical bracket 24 and the horizontal bracket 26 is shown in FIG. 7A, and a top view of the receiver 18 attached to the vertical bracket 24 and the horizontal bracket 26 is shown in FIG. 7B. The brackets 24 and 26 are preferably shaped to reside against the vertical member 30 and the horizontal member 34, and are more preferably approximately semi circular or slightly more than a semi circle to allow the brackets 24 and 26 to snap onto the member 30 and 34 to make assembly easier (e.g., the bracket will temporarily grasp the members until the brackets are secured.)

A receiver 18 with notches 38 in the slot 20 is shown in FIG. 8, and a cross-sectional view taken along line 8A-8A of FIG. 8 of the receiver 18 showing the notches 38 is shown in FIG. 8A. The notches 38 catch a link 42 of the chain 16 when the chain 16 resides in the slot 20. If the gate 12 or chain 16 is pulled horizontally, the link 42 of the chain 16 catches in the notches 38 to prevent accidental opening of the gate 12. When the chain 16 is pulled approximately vertically, the notches 38 do not prevent removal of the chain 16 from the slot 20. The notches 38 are preferably rounded, and more preferably approximately the same shape as a leading edge 40 of the link 42 of the chain 16.

While the invention herein disclosed has been described by means of specific embodiments and applications thereof, numerous modifications and variations could be made thereto by those skilled in the art without departing from the scope of the invention set forth in the claims.

I claim:

1. A latch comprising:
a chain;
a receiver;
a substantially vertical slot in the receiver, the slot configured to vertically receive the chain and to resist a horizontal motion of the chain through the slot; and
a guide proximal to the slot, the guide configured to guide the chain into the slot.

2. The latch of claim 1, wherein:
the receiver is configured to attach proximal to a first vertical member defining a first vertical edge of one of a gate and a gate opening; and
the guide is configured to reside proximal to the first vertical member and to slope downwards and away from the first vertical member towards the slot.

3. The latch of claim 2, wherein:
the receiver includes at least one receiver bracket; and
one of the at least one receiver bracket is configured to attach to the first vertical member.

4. The latch of claim 3, wherein the guide is configured to run downward from the first vertical member to an edge of the slot.

5. The latch of claim 5, wherein the guide is configured to provide a substantially smooth downward path from the first vertical member to the edge of the slot.

6. The latch of claim 3, wherein:
the latch further includes a vertical bracket attached to the receiver and a horizontal bracket attached to the receiver;
the vertical bracket is configured to attach to the first vertical member; and
the horizontal bracket is configured to attach to a horizontal member.

7. The latch of claim 6, wherein the vertical bracket substantially conforms to a profile of the first vertical member and the guide is configured to provide a substantially smooth downward path from the first vertical bracket to the edge of the slot.

8. The latch of claim 7, wherein the horizontal bracket substantially conforms to a profile of the horizontal member.

9. The latch of claim 8, wherein the horizontal bracket and the vertical bracket are approximately semi-circular.

10. The latch of claim 1, further including notches in the slot, wherein the notches are configured to catch a link of the chain to further secure the chain in the slot.

11. The latch of claim 1, wherein:
the chain is attached to a chain bracket; and
the chain bracket is configured to attach to a second vertical member defining a second vertical edge of one of a gate and a gate opening.

12. The latch of claim 11, wherein the chain bracket substantially conforms to a profile of the second vertical member.

13. The latch of claim 11, wherein the chain bracket is approximately semi-circular.

14. Agate latch comprising:
a chain configured to attach to a second vertical member defining a second vertical edge of one of a gate and a gate opening;
a receiver configured to attach to a first vertical member defining a first vertical edge of another of the gate and the gate opening;
a substantially vertical slot in the receiver, the slot configured to vertically receive the chain and to resist a horizontal motion of the chain through the slot; and
a guide proximal to the slot, the guide configured to reside proximal to the first vertical member and to slope away from the first vertical member and downwards towards the slot.

15. The latch of claim 14, wherein:
the latch includes a vertical bracket attached to the receiver and a horizontal bracket attached to the receiver;
the vertical bracket is configured to attach to the first vertical member; and
the horizontal bracket is configured to attach to a horizontal member.

16. The latch of claim 15, wherein the guide is configured to provide a substantially smooth downward path from the first vertical bracket to the edge of the slot.

17. Agate latch comprising:
a vertical bracket configured to attach to a first vertical member defining a first vertical edge of one of a gate and a gate opening;
a receiver attached to the vertical bracket;
a chain configured to attach to a second vertical member defining a second vertical edge of one of the gate and the gate opening;
a substantially vertical slot in the receiver, the slot configured to vertically receive the chain and to resist a horizontal motion of the chain through the slot; and
a guide proximal to the slot, the guide configured to reside proximal to the first vertical member and to slope away from the first vertical member and downwards towards the slot.
